(19) United States
(12) Patent Application Publication
(10) Pub. No.: US 2010/0248829 A1
(43) Pub. Date: Sep. 30, 2010

(54) GAMING PLATFORM AND METHOD USING SAME

(76) Inventor: GEORGE YOUNG, Bayside, NY (US)

Correspondence Address: DALE F. REGELMAN, QUARLES & BRADY, LLP, ONE SOUTH CHURCH AVENUE AVE, STE. 1700, TUCSON, AZ, 85701-1621, US

(21) Appl. No.: 12/620,491

(22) Filed: Nov. 17, 2009

Related U.S. Application Data
(60) Provisional application No. 61/115,418, filed on Nov. 17, 2008.

(51) Int. Cl. A63F 13/00

(52) U.S. Cl. 463/31

(57) ABSTRACT

A gaming platform comprising a semi-circular table comprising a playing surface an arcuate first side, and an opposing arcuate second side, a plurality of player stations arranged along the arcuate first side, a first visual display device comprising a first display screen and disposed within the table such that the first display screen is flush with the playing surface and such that an image displayed on the first display screen can be seen from each of the plurality of player stations, and a second visual display device comprising a second display screen and disposed within the table such that the second display screen is flush with the playing surface and such that an image displayed on the first display screen can be seen from each of the plurality of player stations.

### CROSS-REFERENCE TO RELATED APPLICATIONS

This Application claims priority from a U.S. Provisional Application having Ser. No. 61/115,418 filed Nov. 17, 2008, which is hereby incorporated herein by reference.

### FIELD OF THE INVENTION

The invention is directed to a gaming platform which includes a plurality of visual display devices.

### BACKGROUND OF THE INVENTION

Prior art gaming platforms used for card games generally include a dealer station and one or more player stations. Such prior art gaming platforms do not include any visual display devices disposed therein such that a visual display screen is flush with a playing surface.

### SUMMARY OF THE INVENTION

A gaming platform is presented. The gaming platform comprises a semi-circular table comprising a playing surface an arcuate first side, and an opposing arcuate second side. A plurality of player stations are arranged along the arcuate first side.

The gaming platform further includes a first visual display device comprising a first display screen and disposed within the table such that the first display screen is flush with the playing surface and such that an image displayed on the first display screen can be seen from each of the plurality of player stations. The gaming platform further includes a second visual display device comprising a second display screen and disposed within the table such that the second display screen is flush with the playing surface and such that an image displayed on the first display screen can be seen from each of the plurality of player stations.

### BRIEF DESCRIPTION OF THE DRAWINGS

The invention will be better understood from a reading of the following detailed description taken in conjunction with the drawings in which like reference designators are used to designate like elements, and in which:

FIG. 1A is a top view of a first embodiment of Applicant's gaming platform;

FIG. 1B is a top view of the gaming platform of FIG. 1A further showing nine (9) players arranged adjacent a first arcuate side and a dealer located adjacent an opposing second arcuate side;

FIG. 1C is a top view of a second embodiment of Applicant's gaming platform;

FIG. 1D is a top view of the gaming platform of FIG. 2A further showing nine (9) players arranged adjacent a first arcuate side and a dealer located adjacent an opposing second arcuate side;

FIG. 2 is a block diagram illustrating the components of a controller disposed within Applicant's gaming platform;

FIG. 3 is a top view of the gaming platform of FIG. 1A wherein a first visual display device is displaying an image of a generic (suitless) three card;

FIG. 4 is a top view of the gaming platform of FIG. 1A wherein a first visual display device is displaying an image of a generic (suitless) four card;

FIG. 5 is a top view of the gaming platform of FIG. 1A wherein a first visual display device is displaying an image of a generic (suitless) five card; and

FIG. 6 is a top view of the gaming platform of FIG. 1A wherein a first visual display device is displaying an image of a joker card.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

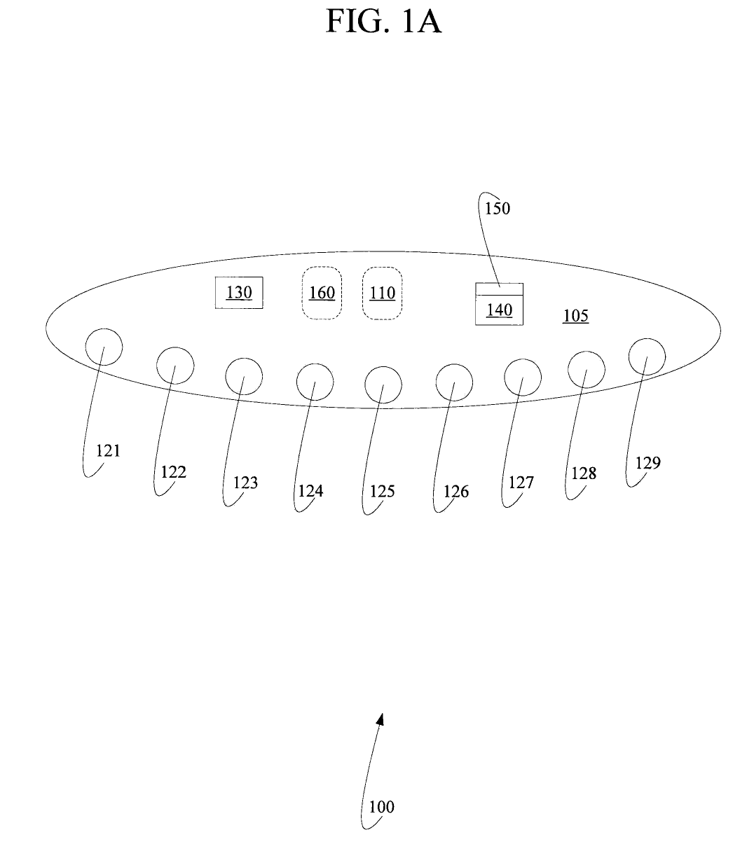

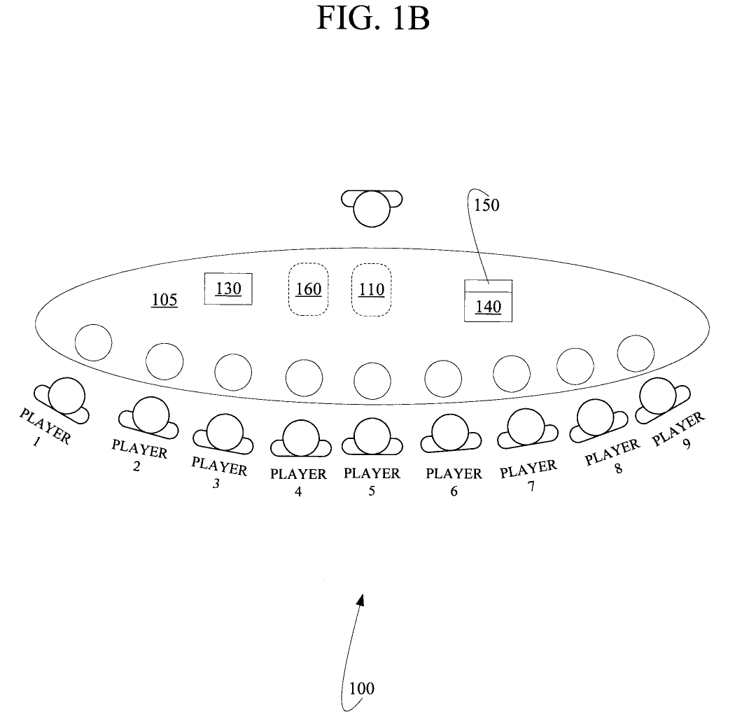

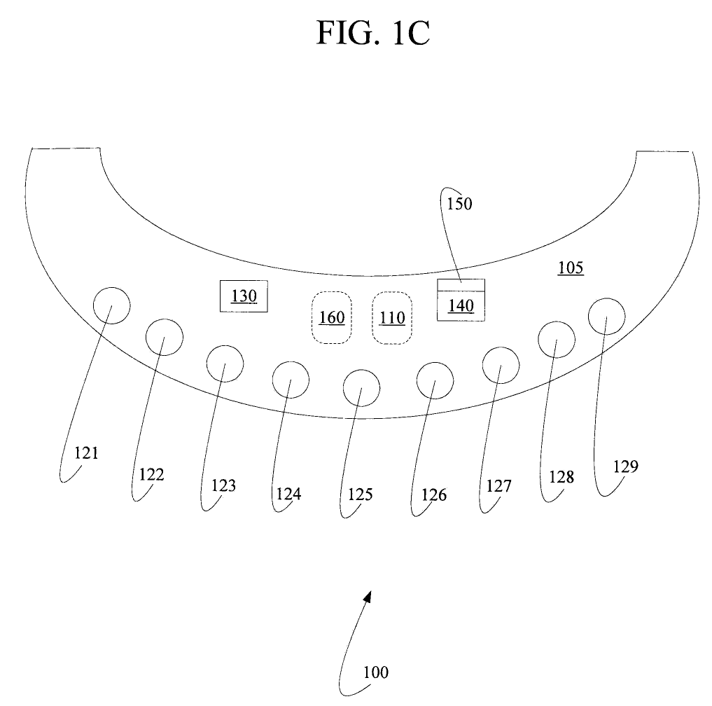

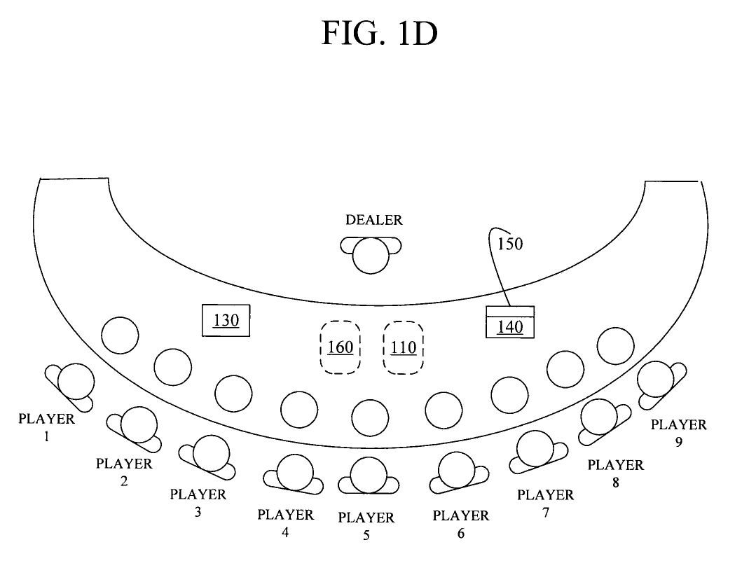

Referring now to FIG. 1A, gaming platform 100 comprises playing surface 105, a visual display device 110 disposed within table 100 such that a visual display screen of device 110 is flush with playing surface 105, a visual display device 160 disposed within table 100 such that a visual display screen of device 160 is flush with playing surface 105, card club scanner 130, money drop 140, currency scanner 150, and a plurality of player stations 120. Each player station is defined by a light emitting device, wherein that light emitting device is disposed within gaming platform 100 such that a top surface of the light emitting device is flush with gaming surface 105.

In the illustrated embodiment of FIG. 1A, gaming platform 100 comprises nine light emitting devices, namely light emitting devices 121, 122, 123, 124, 125, 126, 127, 128, and 129. In certain embodiments, each light emitting device comprises a light emitting diode (“LED”). In certain embodiments, each light emitting device comprises a LED that emits a white color when energized. In certain embodiments, each light emitting device comprises a LED that emits a red color when energized. In certain embodiments, each light emitting device comprises a LED that emits a blue color when energized. In certain embodiments, each light emitting device comprises a plurality of LEDs, wherein each LED can emits one of a plurality of different colors when energized.

FIG. 1C illustrates another embodiment of Applicant's gaming platform 100 comprising a differing gaming surface configuration. The embodiment of FIG. 1C comprises the same elements as described hereinabove with reference to the embodiment of FIG. 1A.

Referring now to FIGS. 1B and 1D, each light emitting device defines a different player station. The illustrated embodiments of FIGS. 1B and 1D show a total of nine (9) players and one dealer disposed adjacent gaming platform 100. In other embodiments, Applicant's gaming platform 100 comprises fewer than nine (9) light emitting devices/player stations. In yet other embodiments, Applicant's gaming platform 100 comprises more than nine (9) light emitting devices/player stations.

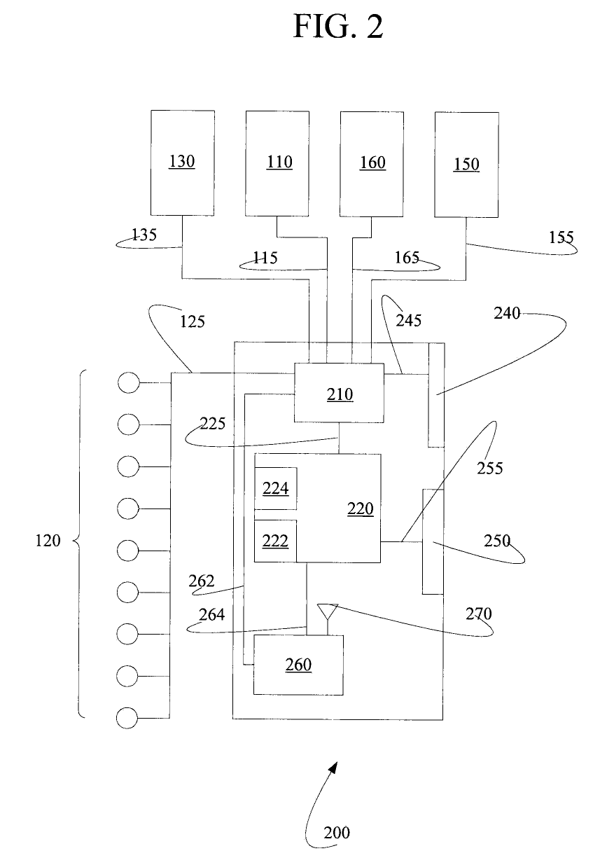

FIG. 2 is a block diagram illustrating certain electronic elements of Applicant's gaming platform 100. Referring now to FIG. 2, gaming platform 100 comprises controller 200 which comprises a processor 210, computer readable medium 220 in communication with processor 210 via communication link 225, a visual display device 240 in communication with processor 210 via communication link 245, a data input device 250 in communication with processor 210 via communication link 255, a network interface module 260 in communication with processor 210 via communication link 262 and in communication with computer readable medium 220 via communication link 264. In certain embodiments, network interface 260 comprises antenna 270. In certain embodiments, network interface 260 is in communication with one or more servers via one or more wireless networks utilizing an IEEE 802.11g (WLAN) protocol and/or an IEEE 802.15.3 (Bluetooth) protocol.

In the illustrated embodiment of FIG. 2, processor 210 is in communication with each of the plurality of light emitting devices 120 via communication link 125. In certain embodiments, a player may elect certain options to play in an upcoming card game dealt by a dealer standing adjacent gaming platform 100. When a player informs the dealer of his/her election to participate in a certain option, the dealer can utilize data input device 240 and provide the player's option selection to processor 210. In certain embodiments, processor 210 encodes the player's option selection in database 224. In certain embodiments, processor causes a light emitting device defining the player station occupied by the selecting player to emit light comprising a certain color. The energized light emitting device signals other players and the dealer that the selecting player has elected to play a card game using a certain option.

In the illustrated embodiment of FIG. 2, processor 210 is in communication with club card scanner 130 via communication link 135. As those skilled in the art will appreciate, many gaming establishments maintain an association of persons, i.e. club members, wherein each club member is issued a card comprising a unique identifier. When a club members joins gaming platform 100, that club member proffers his/her club card to a dealer at gaming platform 100, and that dealer positions the player's club card in near proximity to scanner 130. Scanner 130 reads certain information from that player's club card, and provides that information to processor 210. In certain embodiments, processor 210 then stores that information in a database 224 encoded in computer readable medium 220. In certain embodiments, processor provides the players club card information to a central server via network interface 260.

In the illustrated embodiment of FIG. 2, processor 210 is in communication with currency scanner 150 via communication link 155. As those skilled in the art will appreciate, when a player joins gaming platform 100 that player may proffer currency to a dealer. The dealer exchanges the proffered currency for an equivalent value of playing chips. The dealer then drops the proffered currency through currency slot 140. In certain embodiments, currency slot 140 is interconnected to a local currency collection device. In other embodiments, currency slot 140 is in pneumatic connection with a central currency collection facility.

In either case, as each piece of currency passes through currency slot 140, currency scanner 150 scans and obtains an image of that paper currency, and provides that image to processor 210. In certain embodiments, processor provides the currency image to a central server via network interface 260.

In the illustrated embodiment of FIG. 2, processor 210 is in communication with visual display device 110 via communication link 115. In the illustrated embodiment of FIG. 2, processor 210 is in communication with visual display device 160 via communication link 165. In certain embodiments of Applicant's method utilizing gaming platform 100, one player participating in an upcoming card game can designated certain cards as “Wild Cards.” Having learned of the designation made by an authorized player, a dealer can provide the player's designation to processor 210 via data input device 250. Processor 210 than displays the authorized player's designation on visual display device 110. All players participating in the upcoming card game at gaming platform 110 are then placed on notice of the authorized player's designation. In certain embodiments, processor 210 also displays both the identity of the authorized player, and/or the authorized player's designation, on visual display device 240 such that the dealer is continuously placed on notice of the authorized player's identify and/or the authorized player's designation.

The following Examples are presented to further illustrate to persons skilled in the art how to make and use the invention. These Examples are not intended as a limitation, however, upon the scope of the invention.

### Example I

One embodiment of Applicant's method utilizing gaming platform 100 comprises a 5 or 7 card poker game played from a standard deck of 52 playing cards. A player on the dealer's left side is selected as an Authorized Player, such as for example Player 9 (FIGS. 1B, 1D). In certain embodiments, the Authorized Player designation changes with each hand played. As an example, in a next hand played Player 8 is selected as the Authorized Player.

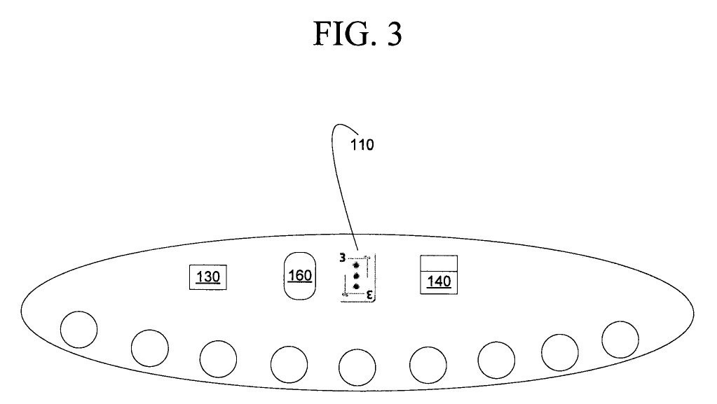

The Authorized Player may designate 3s, or 4s, or 5s as a wild playing cards. For example and referring to FIG. 3, if an Authorized Player designates 3s as wild, then that designation gives Wild Card Status to the 3 of Diamonds, 3 of Hearts, 3 of Clubs, and 3 of Spades. The dealer than provides the Authorized Player's designation to processor 210 via data input device 250. Processor 210 then causes visual display device, and also optionally visual display device 240, to visually display a generic (suitless) three card as shown in FIG. 3. All players participating in the upcoming poker game are thereby placed on notice that all 3s are designated Wild Cards.

In certain embodiments, Applicant's method includes paying a Bonus to any player holding all four of the designated Wild Cards. Under these embodiments in this Example I, a player holding all four 3s would win the Bonus. In certain embodiments, visual display device 160 visually displays the All Wildcard Bonus Amount. In certain embodiments, the All Wildcard Bonus Amount is Five Thousand Dollars ($5,000.00).

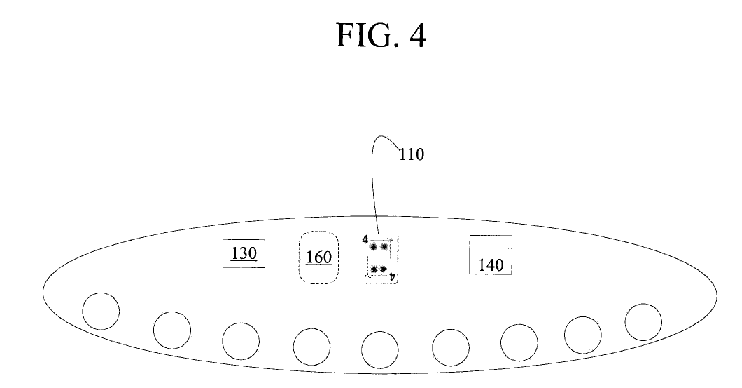

As another example and referring to FIG. 4, if an Authorized Player designates 4s as wild, then that designation gives Wild Card Status to the 4 of Diamonds, 4 of Hearts, 4 of Clubs, and 4 of Spades. The dealer than provides the Authorized Player's designation to processor 210 via data input device 250. Processor 210 then causes visual display device, and also optionally visual display device 240, to visually display a generic (suitless) four card as shown in FIG. 4. All players participating in the upcoming poker game are thereby placed on notice that all 4s are designated Wild Cards.

In certain embodiments, Applicant's method includes paying a Bonus to any player holding all four of the designated Wild Cards. Under these embodiments in this Example I, a player holding all four 4s would win the Bonus. In certain embodiments, visual display device 160 visually displays the All Wildcard Bonus Amount. In certain embodiments, the All Wildcard Bonus Amount is Five Thousand Dollars ($5,000.00).

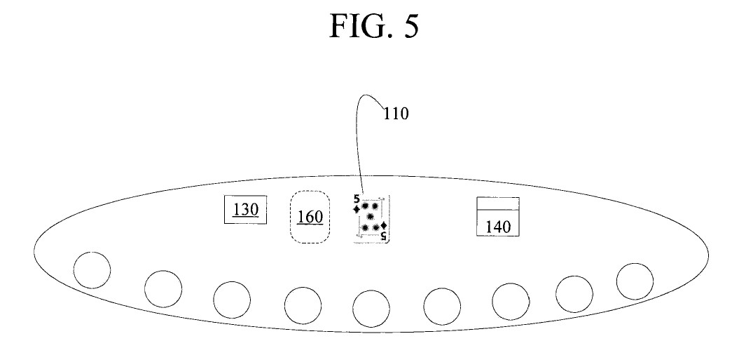

As another example and referring to FIG. 5, if an Authorized Player designates 5s as wild, then that designation gives Wild Card Status to the 5 of Diamonds, 5 of Hearts, 5 of Clubs, and 5 of Spades. The dealer than provides the Authorized Player's designation to processor 210 via data input device 250. Processor 210 then causes visual display device, and also optionally visual display device 240, to visually display a generic (suitless) five card as shown in FIG. 4. All players participating in the upcoming poker game are thereby placed on notice that all 5s are designated Wild Cards.

In certain embodiments, Applicant's method includes paying a Bonus to any player holding all four of the designated Wild Cards. Under these embodiments in this Example I, a player holding all four 5s would win the Bonus. In certain embodiments, visual display device 160 visually displays the All Wildcard Bonus Amount. In certain embodiments, the All Wildcard Bonus Amount is Five Thousand Dollars ($5,000.00).

As those skilled in the art will appreciate, Wild Cards have the ability to become any card in the deck and could be used to aid a player's Poker Hand. For example, if a player holds 4 clubs in his Poker Gone Wild Poker hand, the player can use a wild card(s) to make a Poker Gone Wild Flush Hand. The player with the best 5 cards out of a 7 card hand wins. A natural (using no Wild Cards) Royal Straight Flush beats all other hands. Highest Five of a kind beats all other hands except a natural Straight Flush.

To play five card poker, a minimum of 2 players are needed, and as many as ten (10) players for 5 card poker. To play seven (7) card poker, a minimum 2 players are needed, and up to 22 players for Texas Hold'em Poker using one standard deck of 52 playing cards. In the case of Texas Hold'em using 3s, 4s, or 5s as wild cards a minimum of two (2) players are needed to play with as many as 22 players playing.

### Example II

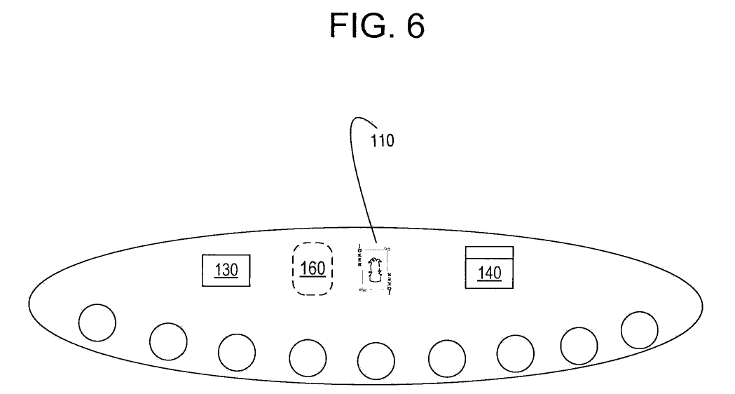

In certain embodiments, a dealer elects to designate two Joker cards as Wild Cards, and uses 54 playing cards with the two Joker Cards included (52 standard playing cards with an additional 2 Jokers for a total of 54 playing cards). In this embodiment the dealer provides to processor 210 using data input device 250 his/her election to use two Joker Cards as Wild Cards. Referring now to FIG. 6, processor 210 then causes visual display device 110, and optionally visual display device 240, to visually display a Joker Card. The players participating in the next card game dealt are thereby placed on notice that two Joker Cards will be used as Wild cards.

In certain embodiments, Applicant's method includes paying a Bonus to any player holding all four of the designated Wild Cards. Under these embodiments in this Example I, a player holding both Joker Cards would win the Bonus. In certain embodiments, visual display device 160 visually displays the All Wildcard Bonus Amount. In certain embodiments, the All Wildcard Bonus Amount is Five Thousand Dollars ($5,000.00).

In this Example II, at least 2 players are needed for Five (5) Card Poker with The Jokers as Wild Cards. As many as ten (10) players could participate in five (5) Card Poker with The Jokers as Wild Cards.

At least two (2) players are needed to play seven (7) card poker with the Jokers as Wild Cards. As many as seven (7) players could participate in seven (7) card poker with The Jokers as Wild Cards.

In the case of Texas Hold'em with The Jokers as wild cards and a deck of 54 playing cards, a minimum of two (2) players are needed to play with as many as 23 players participating.

While the preferred embodiments of the present invention have been illustrated in detail, it should be apparent that modifications and adaptations to those embodiments may occur to one skilled in the art without departing from the scope of the present invention as set forth in the following claims.

I claim:

1. A gaming platform, comprising:
a semi-circular table comprising a playing surface, an arcuate first side, and an opposing arcuate second side;
a plurality of player stations disposed along said arcuate first side;
a first visual display device comprising a first display screen and disposed within said table such that said first display screen is flush with said playing surface and such that an image displayed on said first display screen can be seen from each of said plurality of player stations;
a second visual display device comprising a second display screen and disposed within said table such that said second display screen is flush with said playing surface and such that an image displayed on said first display screen can be seen from each of said plurality of player stations.
